(19) United States
(12) Patent Application Publication
(10) Pub. No.: US 2018/0180955 A1
(43) Pub. Date: Jun. 28, 2018

(54) LIQUID CRYSTAL DISPLAY PANEL

(71) Applicant: WUHAN CHINA STAR OPTOELECTRONICS TECHNOLOGY CO., LTD., WUHAN, HUBEI (CN)

(72) Inventors: YUXIA CHEN, WUHAN, HUBEI (CN); CHAO HE, WUHAN, HUBEI (CN)

(73) Assignee: WUHAN CHINA STAR OPTOELECTRONICS TECHNOLOGY CO., LTD., WUHAN, HUBEI (CN)

(21) Appl. No.: 15/304,252

(22) PCT Filed: Jun. 3, 2016
(86) PCT No.: PCT/CN2016/084759

§ 371 Date: Oct. 14, 2016

(30) Foreign Application Priority Data
Feb. 29, 2016 (CN) 201610112043.8

(51) Int. Cl. G02F 1/1362; G02F 1/1335; G02F 1/1368

(52) U.S. Cl. CPC G02F 1/136209; G02F 1/133528; G02F 2001/133302; G02F 1/133514; G02F 2202/104; G02F 1/1368

(57) ABSTRACT

An LCD panel is provided, which includes a substrate, a polarizing sheet disposed on a surface of the substrate, and a device disposed on another surface of the substrate. The device forms a device area. The LCD panel further includes a shielding layer, which is embedded within the polarizing sheet or disposed on the upper surface or lower surface of the polarizing sheet. The device area is blocked by the shielding layer to prevent generation of a photo leakage current. The present invention has the following advantages. The shielding layer and a poly-silicon layer are individually formed, thereby avoiding a damage caused by static electricity between a poly-silicon layer and a shielding layer (that is caused by forming the poly-silicon layer onto the surface of the shielding layer in the prior art), as well as reducing the manufacture of the metal-shielding layer of traditional LTPS technology, thereby reducing production costs.

### BACKGROUND OF THE INVENTION

### 1. Field of the Invention

The present invention relates to a field of liquid crystal display (LCD) technology, and more specifically to an LCD panel.

### 2. Description of the Prior Art

With the increasing popularization of mobile displays, the development of a new generation of mobile display technology is tending towards high definition, high resolution, lightening and thinning, and low power consumption. For example, the high definition, high resolution, ultra-thin, and low power consumption of low temperature poly-silicon (LTPS) technology are well received by consumers, thus traditional a-Si thin film transistor (TFT) technology is progressively replaced by the LTPS technology, and the LTPS technology has become the mainstream of a new generation of display technology.

Please refer to FIG. 1, in a traditional process for manufacturing a LTPS display, a glass substrate 10 has a metal shielding layer 11 (LS Light Shield) thereon, which is on the farther side from a polarizing sheet 12. A device area is covered by the metal shielding layer 11 to prevent generation of a photo leakage current. The device area can be a TFT area. However, an isolation layer 14 (e.g., the isolation layer 14 is a silicon dioxide layer 142 or a silicon nitride layer 141) of a poly-silicon layer 13 is covered on the area of a cone-shaped slope to correspondingly form the isolation layer 14 having a cone-shaped slope when a TFT is manufactured, due to the metal shielding layer 11 having some thickness and an angle of the cone-shaped slope, so that a damage caused by static electricity of a ESD easily occurs between the position of the cone-shaped slope of the poly-silicon layer 13 and the metal shielding layer 11 (as shown in FIG. 1), thereby resulting in yield loss.

### SUMMARY OF THE INVENTION

A technical problem solved by the present invention is that an LCD panel is provided, the LCD panel is able to inhibit a damage caused by static electricity between a poly-silicon layer and a shielding layer, as well as simplify the process of a liquid crystal panel, thereby reducing production costs.

To overcome the above-mentioned disadvantages, the present invention provides an LCD panel including a substrate, a polarizing sheet disposed on a surface of the substrate, and a device disposed on another surface of the substrate. The device forms a device area. The LCD panel further includes a shielding layer. The shielding layer is embedded within the polarizing sheet, or is disposed on the upper surface of the polarizing sheet or the lower surface of the polarizing sheet. The device area is blocked by the shielding layer to prevent generation of a photo leakage current. The device is a thin film transistor array. A poly-silicon layer is disposed on another surface of the substrate, and the poly-silicon layer is doped to form a channel region of the thin film transistor array. An isolation layer is disposed between the poly-silicon layer and the substrate, and the isolation layer is a silicon dioxide layer, a silicon nitride layer, or a combination thereof.

The present invention further provides an LCD panel including a substrate, a polarizing sheet disposed on a surface of the substrate, and a device disposed on another surface of the substrate. The device forms a device area. The LCD panel further includes a shielding layer. The shielding layer is embedded within the polarizing sheet, or is disposed on the upper surface of the polarizing sheet or the lower surface of the polarizing sheet. The device area is blocked by the shielding layer to prevent generation of a photo leakage current.

Further, the device is a thin film transistor array.

Further, a poly-silicon layer is disposed on another surface of the substrate, and the poly-silicon layer is doped to form a channel region of the thin film transistor array.

Further, an isolation layer is disposed between the poly-silicon layer and the substrate.

Further, the isolation layer is a silicon dioxide layer, a silicon nitride layer, or a combination thereof.

Further, the substrate is a TFT substrate, the liquid crystal display panel further includes a color filter (CF) substrate opposite the TFT substrate, and a liquid crystal layer is disposed between the TFT substrate and the CF substrate.

Further, the color filter substrate has a polarizing sheet thereon, which is on the farther side from the thin film transistor substrate.

Further, the substrate is a glass substrate.

Further, the shielding layer is a metal shielding layer.

The present invention has the following advantages. The shielding layer for blocking the device area is formed on the polarizing sheet, thereby avoiding a poly-silicon layer to be formed on a shielding layer having some thickness and an angle of a cone-shaped slope. The shielding layer and the poly-silicon layer are individually formed, thereby avoiding a damage caused by static electricity between a poly-silicon layer and a shielding layer (that is caused by forming the poly-silicon layer onto the surface of the shielding layer in the prior art), as well as reducing the manufacture of the metal shielding layer of traditional LTPS technology, thereby saving a manufacturing step and reducing production costs.

### BRIEF DESCRIPTION OF THE DRAWINGS

FIG. 1 is a schematic view of the location of a shielding layer in a traditional process for manufacturing a LTPS display; and

FIG. 2 is a schematic view of the location of the shielding layer of an LCD panel according to the present invention.

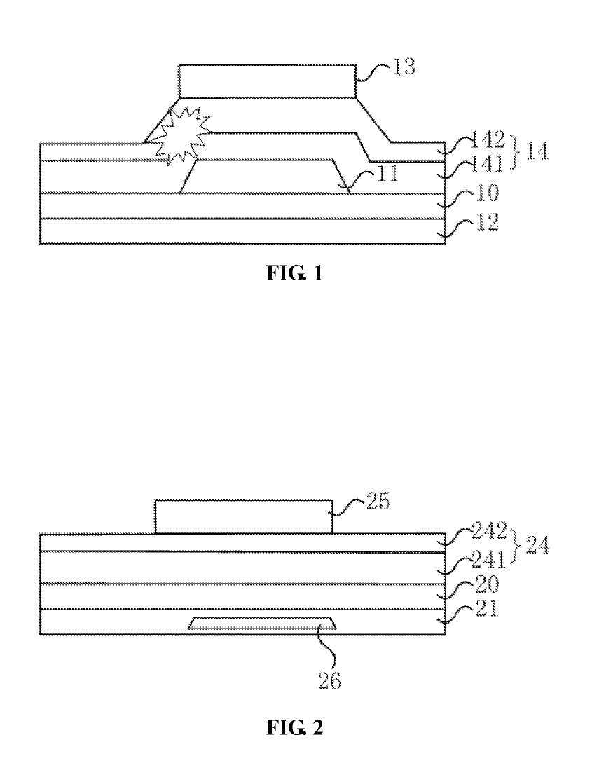

### DETAILED DESCRIPTION OF THE PREFERRED EMBODIMENTS

The specific embodiment of an LCD panel provided by the present invention will now be described with reference to annexed drawings.

Please refer to FIG. 2, the TFT substrate of LTPS technology that is selected as the embodiment is explained.

The LCD panel includes a substrate 20, a polarizing sheet 21 disposed on a surface of the substrate 20, and a device (not shown in the figure) disposed on another surface of the substrate 20. The device forms a device area.

In the embodiment, the substrate 20 is a glass substrate, and the substrate 20 is a TFT substrate. The TFT substrate has a TFT array (not shown in the figure) thereon, which is on the farther side from the polarizing sheet 21. In the embodiment, the device is the TFT array, and the device area is a TFT array area.

When the TFT array is manufactured, a poly-silicon layer 25 is formed on the surface of the substrate 20, the poly-silicon layer 25 can be doped to form the channel region of the TFT array. Further, an isolation layer 24 is further formed between the substrate 20 and the poly-silicon layer 25. The isolation layer 24 can be a silicon dioxide layer, a silicon nitride layer, or a combination thereof. In the embodiment, the isolation layer 24 sequentially includes a silicon nitride layer 241 and a silicon dioxide layer 242 based on the substrate 20. The poly-silicon layer 25 is disposed on the surface of the silicon dioxide layer 242. There is no protuberance caused by a shielding layer due to the isolation layer 24 and the poly-silicon layer 25 being directly disposed on the surface of the substrate 20, rather than the shielding layer being disposed on the surface of the substrate 20, as described by the prior art, thereby avoiding a damage caused by static electricity between the poly-silicon layer 25 and the shielding layer.

A shielding layer 26 is embedded within the polarizing sheet 21 or is disposed on the upper surface of the polarizing sheet 21 or the lower surface of the polarizing sheet 21 in order to be still able to achieve the effect of the shielding device area of a shielding layer in the prior art and in order to avoid a damage caused by static electricity between the poly-silicon layer 25 and the shielding layer. The device area is blocked by the shielding layer 26 to prevent generation of a photo leakage current. In the embodiment, the shielding layer 26 is embedded within the polarizing sheet 21. When the polarizing sheet 21 is manufactured, the shielding layer 26 is directly embedded within the polarizing sheet 21, or is directly formed on the upper surface of the polarizing sheet 21 or the lower surface of the polarizing sheet 21. The shielding layer 26 can be a metal layer or a non-metal layer, as long as be able to prevent the generation of the photo leakage current, but the present invention is not limited thereto. One having ordinary skill in the art can obtain the structures and materials of the shielding layer 26 from the shielding layer of existing LTPS technology.

Further, in the embodiment, the LCD panel further includes a CF substrate (not shown in the figure) opposite the TFT substrate, and a liquid crystal layer (not shown in the figure) is disposed between the TFT substrate and the CF substrate. The color filter substrate has a polarizing sheet (not shown in the figure) thereon, which is on the farther side from the thin film transistor substrate. The structure of the LCD panel is a conventional structure in the art, and therefore will not be redundantly stated herein.

An example of a method for manufacturing an LCD panel of the present invention will be given hereinafter for CMOS LTPS FFS technology, so as to further explain the structure of the LCD panel of the present invention.

The method for manufacturing the LCD panel of the CMOS LTPS FFS technology includes the following steps (1-10).

In step (1), a poly-silicon layer is manufactured (the shielding layer of the first step of a traditional process is omitted). In step (2), an N-MOS Channel is manufactured by doping. In step (3), N+ doping is performed. In step (4), a GE layer, a GI layer, and a LDD layer are manufactured. In step (5), P+ doping is performed. In step (6), an ILD layer is manufactured. In step (7), an SD layer is manufactured. In step (8), a PLN layer is manufactured. In step (9), a BITO layer is manufactured. In step (10), a PV layer is manufactured. In step (11), a TITO layer is manufactured. In step (12), a polarizing sheet having a light-shading film is spliced after the TFT substrate is manufactured and the CF substrate is assembled.

The disposition of the shielding layer of the LCD panel of the present invention can be used for the product design of CMOS/NMOS/Top Gate in addition to be used for the product design of the TFT backboard of LTPS technology. Also, the disposition of the shielding layer of the LCD panel of the present invention applies not only to a FFS structure, but also to other display structures such as an IPS structure and the like, and to the product design of an in-cell-touch structure.

The above are exemplary embodiments of the present disclosure. It should be noted that a number of improvements and modifications may be made by those of ordinary skill in the art without departing from the principles of the present disclosure, and should be considered as falling within the scope of the disclosure.

What is claimed is:

1. A liquid crystal display panel, comprising a substrate, a polarizing sheet disposed on a surface of the substrate, and a device disposed on another surface of the substrate, the device forming a device area, wherein the liquid crystal display panel further comprises a shielding layer, the shielding layer is embedded within the polarizing sheet or is disposed on an upper surface of the polarizing sheet or a lower surface of the polarizing sheet, the device area is blocked by the shielding layer to prevent generation of a photo leakage current, the device is a thin film transistor array, a poly-silicon layer is disposed on another surface of the substrate, the poly-silicon layer is doped to form a channel region of the thin film transistor array, an isolation layer is disposed between the poly-silicon layer and the substrate, and the isolation layer is a silicon dioxide layer, a silicon nitride layer, or a combination thereof.

2. The liquid crystal display panel of claim 1, wherein the substrate is a thin film transistor substrate, the liquid crystal display panel further comprises a color filter substrate opposite the thin film transistor substrate, and a liquid crystal layer is disposed between the thin film transistor substrate and the color filter substrate.

3. The liquid crystal display panel of claim 2, wherein the color filter substrate has a polarizing sheet thereon, which is on the farther side from the thin film transistor substrate.

4. The liquid crystal display panel of claim 1, wherein the substrate is a glass substrate.

5. The liquid crystal display panel of claim 1, wherein the shielding layer is a metal shielding layer.

6. A liquid crystal display panel, comprising a substrate, a polarizing sheet disposed on a surface of the substrate, and a device disposed on another surface of the substrate, the device forming a device area, wherein the liquid crystal display panel further comprises a shielding layer, the shielding layer is embedded within the polarizing sheet or is disposed on an upper surface of the polarizing sheet or a lower surface of the polarizing sheet, the device area is blocked by the shielding layer to prevent generation of a photo leakage current.

7. The liquid crystal display panel of claim 6, wherein the device is a thin film transistor array.

8. The liquid crystal display panel of claim 7, wherein a poly-silicon layer is disposed on another surface of the substrate, and the poly-silicon layer is doped to form a channel region of the thin film transistor array.

9. The liquid crystal display panel of claim 8, wherein an isolation layer is disposed between the poly-silicon layer and the substrate.

10. The liquid crystal display panel of claim 9, wherein the isolation layer is a silicon dioxide layer, a silicon nitride layer, or a combination thereof.

11. The liquid crystal display panel of claim 6, wherein the substrate is a thin film transistor substrate, the liquid crystal display panel further comprises a color filter substrate opposite the thin film transistor substrate, and a liquid crystal layer is disposed between the thin film transistor substrate and the color filter substrate.

12. The liquid crystal display panel of claim 11, wherein the color filter substrate has a polarizing sheet thereon, which is on the farther side from the thin film transistor substrate.

13. The liquid crystal display panel of claim 6, wherein the substrate is a glass substrate.

14. The liquid crystal display panel of claim 6, wherein the shielding layer is a metal shielding layer.
